(19) United States
(12) Patent Application Publication
(10) Pub. No.: US 2016/0092815 A1
(43) Pub. Date: Mar. 31, 2016

(54) MONITORING RESOURCES IN A PARTNERSHIP PROGRAM

(71) Applicant: HEWLETT-PACKARD DEVELOPMENT COMPANY, L.P., Houston, TX (US)

(72) Inventors: Brenda Anderson Hunter, Woodinville, CA (US); Balaji S. Naidu, Bangalore (IN); Simky Dey, Bangalore (IN); Ambuj Agarwal, Bangalore (IN); Pushon Mukerjee, Bangalore (IN)

(21) Appl. No.: 14/891,230

(22) PCT Filed: May 20, 2013
(86) PCT No.: PCT/US2013/041876

§ 371 Date: Nov. 13, 2015

(51) Int. Cl. G06Q 10/06

(52) U.S. Cl. CPC G06Q 10/06313

(57) ABSTRACT

Techniques for monitoring partnership programs are described herein. The techniques may determining, via a tracking module, a contra value indicating an amount spent by a first company on a partnership program in which the first company has partnered with a second company to market and sell products or services of the first company. The techniques may include determining, via an optimization module, an optimization value indicating a future amount to be allocated to the partnership program based on factors. The factors may include coefficients indicating a rate of change of revenue based on historical contra values, a historical contra value minimum, a historical contra value maximum, and a historical contra value median.

### BACKGROUND

A company may engage in marketing activities to sell products or services to customers. In order to increase revenue, a first company may engage in a channel partnership with a second company. In a channel partnership the first company may provide resources to the second company to incentivize the second company to market and sell the products and services of the first company. The resources provided may depend on a number of factors. For example, the resources provided may depend on particular partnership program designed by the first company. The resources provided may also depend on a contractual agreement between the first company and the second company. In another example, the resources provided may depend on an amount of discretionary money available to the first company to spend on marketing efforts in a given partnership or partnership program.

### BRIEF DESCRIPTION OF DRAWINGS

Certain examples are described in the following detailed description and in reference to the drawings, in which:

FIG. 1 is a block diagram of a computing system configured to monitor resources in a partnership program;

FIG. 2 is a block diagram the efficiency engine of FIG. 1;

FIGS. 3A-3F are diagrams illustrating a graphical user interface associated with a tracking tool;

FIGS. 4A-4C are diagrams illustrating a graphical user interface associated with an efficiency tool;

FIGS. 5A-5E are diagrams illustrating a graphical user interface associated with an optimization tool;

FIG. 6 is a block diagram illustrating a method for monitoring resources in a business partnership program; and

FIG. 7 is a block diagram showing a tangible machine-readable medium that stores code adapted to arrange video images associated with audiovisual streams in a multi-stream environment.

### DETAILED DESCRIPTION

The subject matter disclosed herein relates to monitoring resources in a business partnership program. A first company having a product or service may engage in a partnership with a second company. The partnership may be based on an agreement by the second company to engage in marketing and selling of the products or services of the first company in exchange for incentives provided by the first company. For example, the first company may offer the second company a discount on bulk orders of a product, a rebate on products or services sold in a given partnership program, and the like. The incentive offered may be considered a contra value indicating an amount spent by the first company in the partnership with the second company. The contra value may be monitored and metrics may be determined to enable a user to evaluate the effectiveness of resources spent on any given partnership, partnership program, on a given product or product line, and the like. Further, suggestions for future budget decisions may be determined based on the historical contra values monitored.

A “company,” as referred to herein, is an enterprise, an individual, a corporation, and the like, having a product or service for sale or trade. The company may engage in partnerships with a second company to sell products or services of the first company.

A “contra value”, as referred to herein, is a value indicating an amount spent by the first company in a program associated with providing resources, such as incentives, to the second company to market and sell the products or services of the first company. The contra value may be related to differentiating variables such as the contra value based on a partnership, a type of discretionary contra value program, a type of product, a product line, and the like.

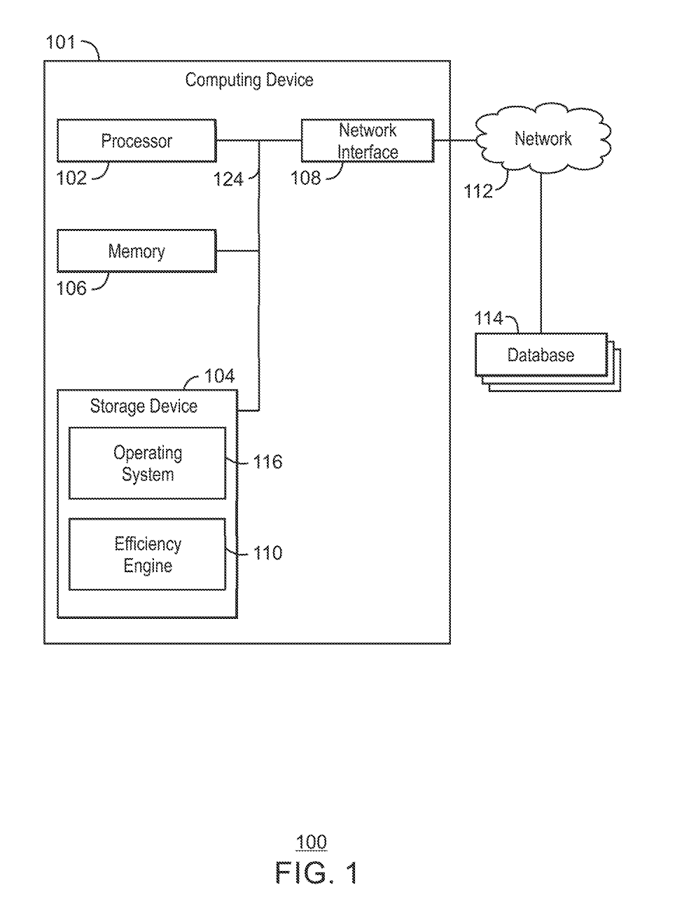

FIG. 1 is a block diagram of a computing system configured to monitor resources in a partnership program. The computing system 100 may include a computing device 101 a processor 102, a storage device 104 comprising a non-transitory computer-readable medium, a memory device 106, and a network interface 108. The computing device 101 may communicate, via the network interface 108, with a network 112 to access one or more external databases 114.

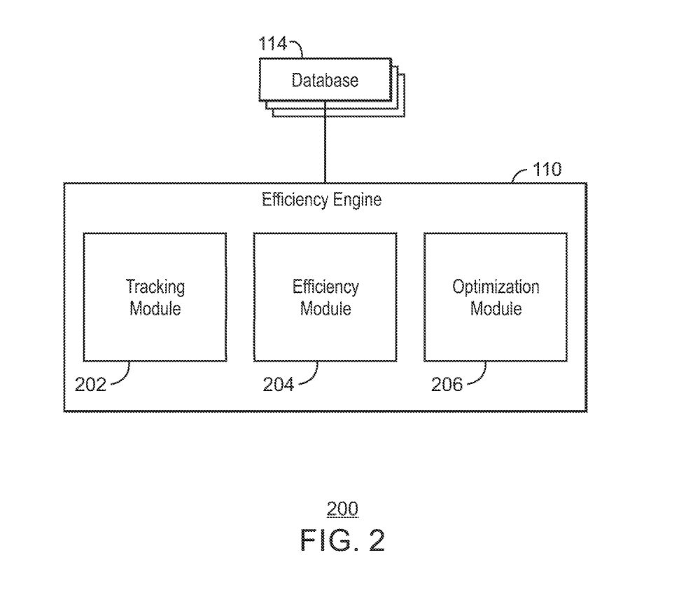

The storage device 104 may include an operating system 116. The operating system 116 may be executed by a processor of a host computing system such as the processor 102 of the computing device 101. The storage device 104 may include an efficiency engine 110. The efficiency engine 110 may be a set of instructions stored on the storage device 104 that when executed by the processor 102, cause the computing device 101 to perform operations. The instructions may include code to direct the processor 102 to determine a contra value indicating an amount spent by a first company on a partnership program in which the first company has partnered with a second company to market and sell products or services of the first company. The instructions may include code to direct the processor 102 to determine an optimization value indicating a future amount to be allocated to the partnership program based on factors discussed below in reference to FIG. 2.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The main processor 102 may be connected through a system bus 124 (e.g., PCI, ISA, PCI-Express, HyperTransport®, NuBus, etc.) to the network interface 108. The network interface 108 may enable the computing device 101 to communicate, via the network 112, with the one or more databases 114. In some examples, the databases 114 may be configured to store data related to contra values, revenue values, partnership type information, and the like.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

FIG. 2 is a block diagram the efficiency engine of FIG. 1. The efficiency engine 110 includes a tracking module 202, an efficiency module 204, and an optimization module 206. As illustrated in FIG. 2, the efficiency engine 110 may be communicatively coupled to the databases 114. The efficiency engine 110 and the modules 110 include a combination of hardware and programming. For example, the engine and/or hardware can be a non-transitory, computer-readable medium for storing the instructions, one or more processors for executing the instructions, or a combination thereof. The efficiency engine 110 may receive data from the databases 114 including contra values, partnership data, discretionary budget data, and the like. The modules 202, 204, 206 of the efficiency engine 110 may determine values based on the data received from the databases 114.

In one example, the tracking module 202 is configured to receive contra values from the databases 114 and determine a contra value indicating an amount spent by a first company on a partnership program in which the first company has partnered with a second company to market and sell products or services of the first company. The tracking module 202 is configured to determine values associated with the contra value. For example, the tracking module 202 determines an aggregate contra value indicating an amount spent across a plurality of partnership programs. The tracking module 202 may determine a revenue amount generated based on a partnership type, wherein the partnership type indicates a type of partnership agreement between the first company and the second company. The tracking module 202 may determine an aggregate contra value based on a product line and program type; wherein a product line is a category of products or services of the first company, and wherein a program type is a segmentation of a contra value allocated for specific objectives. The tracking module 202 may determine an aggregate contra value based on a contra bucket, wherein a contra bucket includes a plurality of program types. The tracking module 202 may determine an aggregate contra value and a revenue value based on a product category comprising product lines at a partner level. The tracking module 202 may determine a percentage value indicating the contra value as a percentage of revenue generated.

The efficiency module 204 may a set of instructions that, when executed by the processor 102 of FIG. 1, direct the processing unit to determine an impact ratio of the contra value to a generated revenue value. The impact ratio is a proportion of the contra value to the revenue generated for the first company.

The optimization module 206 may be a set of instructions that, when executed by the processor 102 of FIG. 1, direct the processing unit to determine an optimization value indicating a future amount to be allocated to the partnership program based on factors. The factors, discussed in more detail below, include coefficients indicating a rate of change of revenue based on historical contra values, a historical contra value minimum, a historical contra value maximum, and a historical contra value median. Some of the factors may be determined by a linear regression of historical contra values provided by the database. In some examples, the coefficients may be based on a statistical model used to predict future revenues. The statistical model may be a linear regression model assuming a hierarchy of populations, such as the Random Effects Model. Based on the historical contra values, the statistical model may be generated projecting future revenues versus the contra values, wherein the coefficients indicate the rate of change of the revenues in view of changes in historical contra values. The optimization module 206 may determine an optimization value indicating a future amount to be allocated to a given partnership program. In some examples, the optimization module 206 may enable a user to select a type of optimization allocation including a conservative allocation or an aggressive allocation as discussed in more detail below.

Each of the tracking module 202, the efficiency module 204, and the optimization module 206 may be represented in a web-based tool. In some examples, the web based tool may provide visualization of contra values as well as visualization of the analysis discussed above.

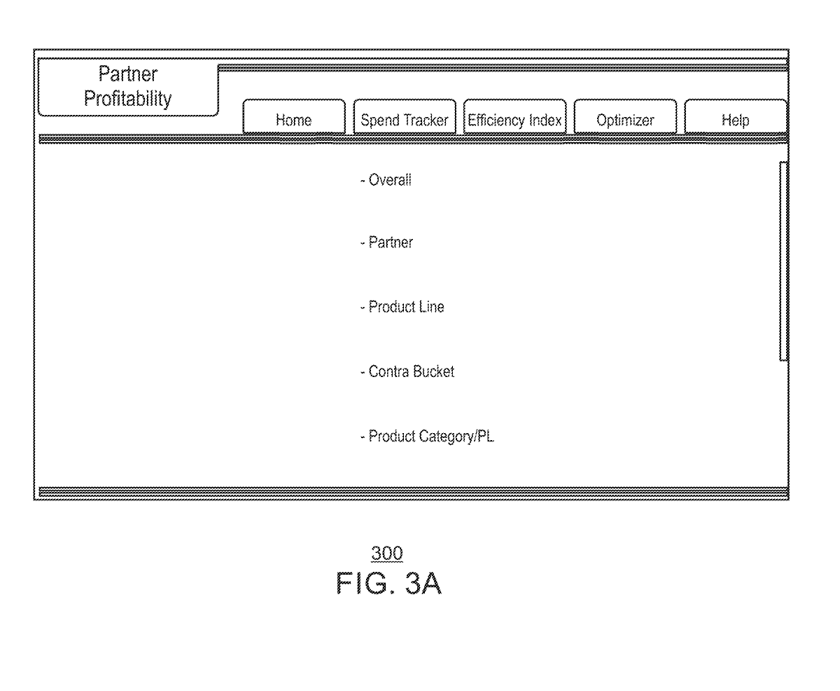

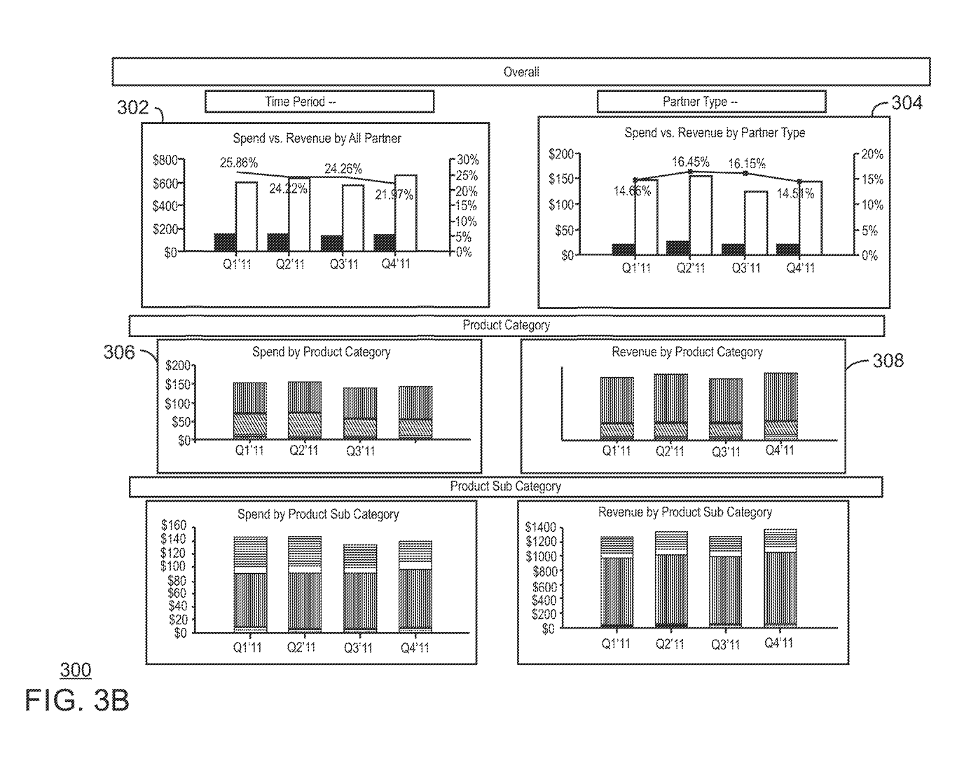

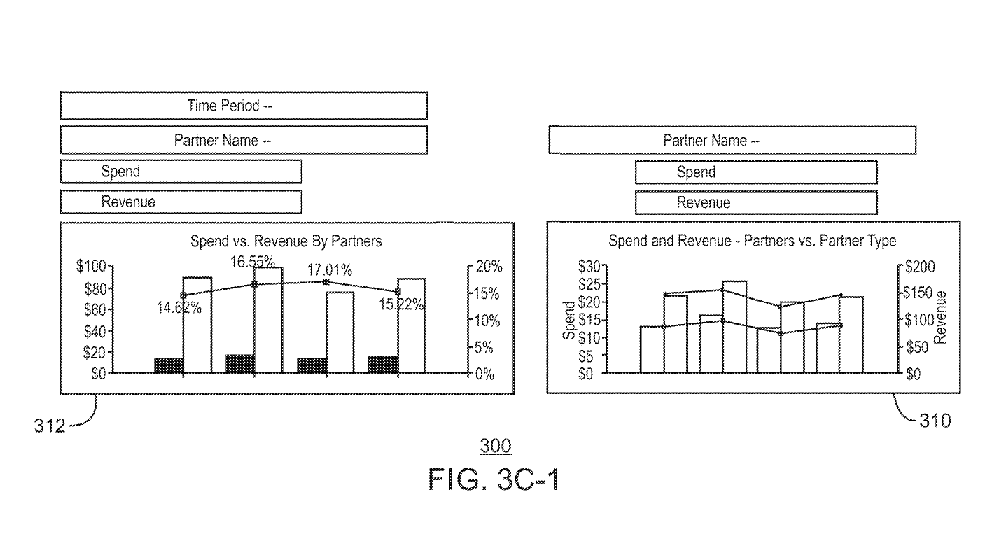

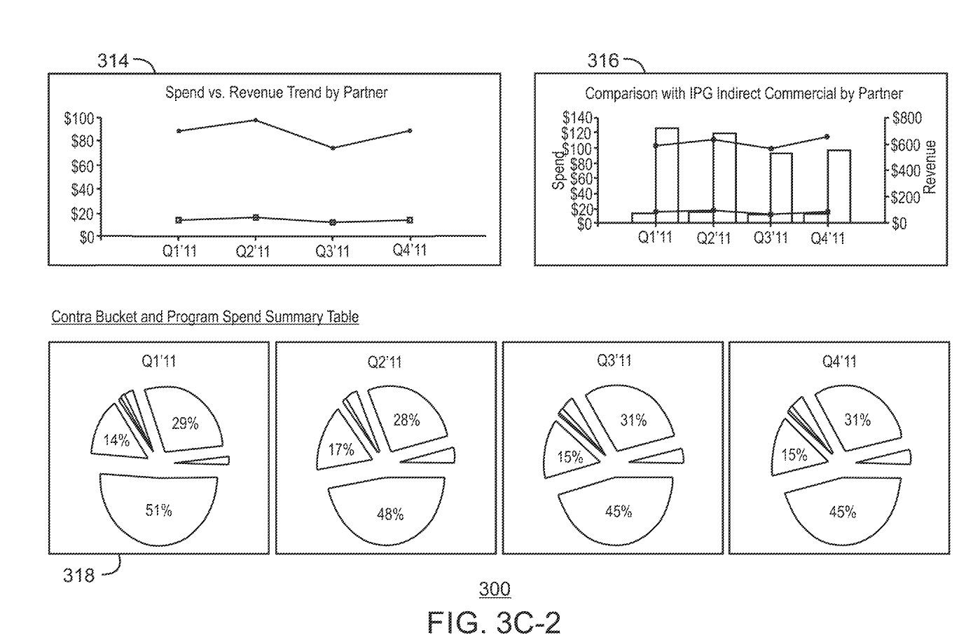

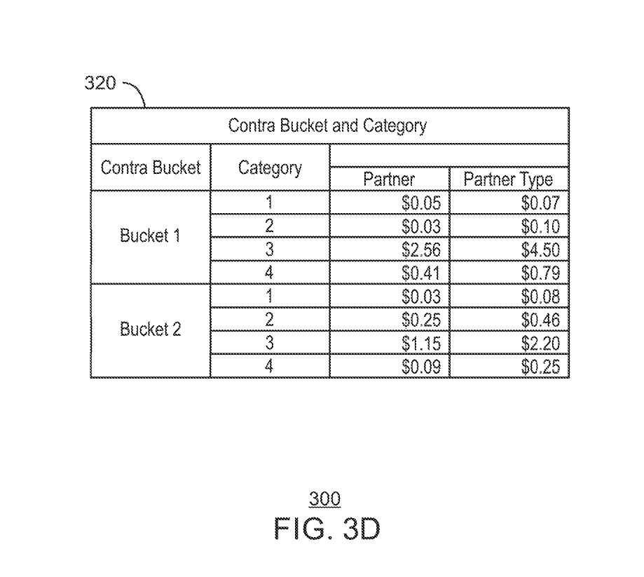

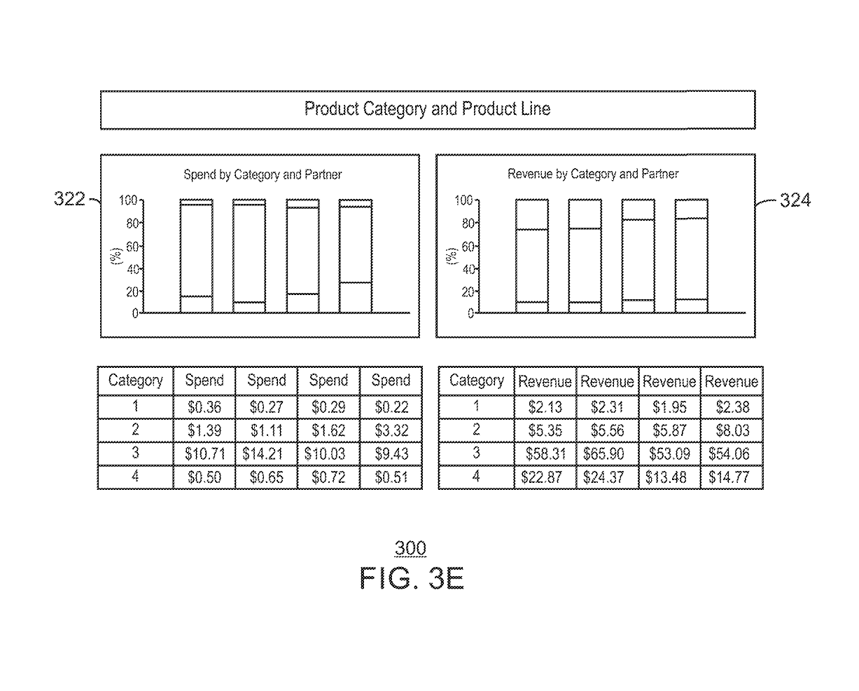

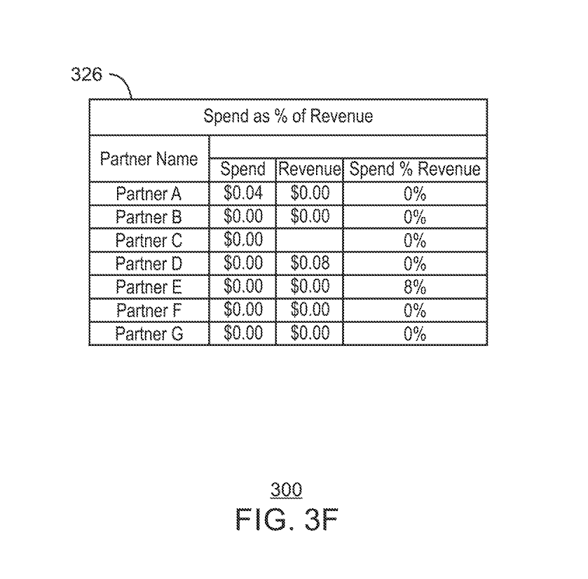

FIGS. 3A-3F are diagrams illustrating a graphical user interface associated with a tracking tool. In FIG. 3A, the tracking tool 300 provides an overview of the tracking tool 300. As illustrated in FIG. 3A, the tracking tool 300 provides a portal to visualizations of contra values at various levels including an overall level, a partner level, a product line level, a contra bucket level, and a product category and partner level. In FIG. 3B, the tracking tool 300 provides a view of contra values versus revenue 302, contra values versus revenue by partner type 304, spend by product category 306, and revenue by product category 308.

As illustrated in FIG. 3C-1, the tracking tool 300 provides visualizations of contra values versus revenue at a partner level and enables comparison between individual partners and the partner types. A partner type is a designation of a plurality of partners that have the same, or similar, agreements with the company to sell the company's products or services. The visualization illustrated in FIG. 3C enables a user to compare the contra value and generated revenue associated with one of the partners of a partner type with the partner type as a whole as illustrated by the graph 310. The tracking tool 300 may provide a visualization of the contra value associated with a partner versus the revenue of the partner as illustrated by the graph 312. As illustrated in FIG. 3C-2, the tracking tool 300 may provide a visualization of the contra value versus revenue as a trend line as illustrated in graph 314, and may provide a visualization of the contra values associated with a partner in comparison to a discretionary contra value as indicated by the graph 316. The tracking tool 300 may provide a pie chart that, in some examples, may be per quarter, of aggregate contra values per contra programs as indicated by the graphs 318.

As illustrated in FIG. 3D, the tracking tool 300 may provide a visualization of the contra bucket and categories within each contra bucket indicated by the table 320. The table 320 illustrates the contra values and enables a user to view actual contra values and compare them with aggregate contra values of the partner type for which the partner is a member.

As illustrated in FIG. 3E, the tracking tool 300 may provide a visualization of the contra values for one partner within a category as indicated by graph 322. The tracking tool may provide a visualization of the generated revenue associated with the category and the partner as indicated by graph 324. As illustrated in FIG. 3F, the tracking tool 300 may provide a visualization of the contra values as a percentage of revenue shown in table 326.

The visualizations illustrated in FIGS. 3A-3F enable a user to compare the contra values in various ways. The visualizations discussed above are not intended to be limiting, and the tracking tool 300 may provide additional visualizations, or fewer visualizations, depending on the specific implementation.

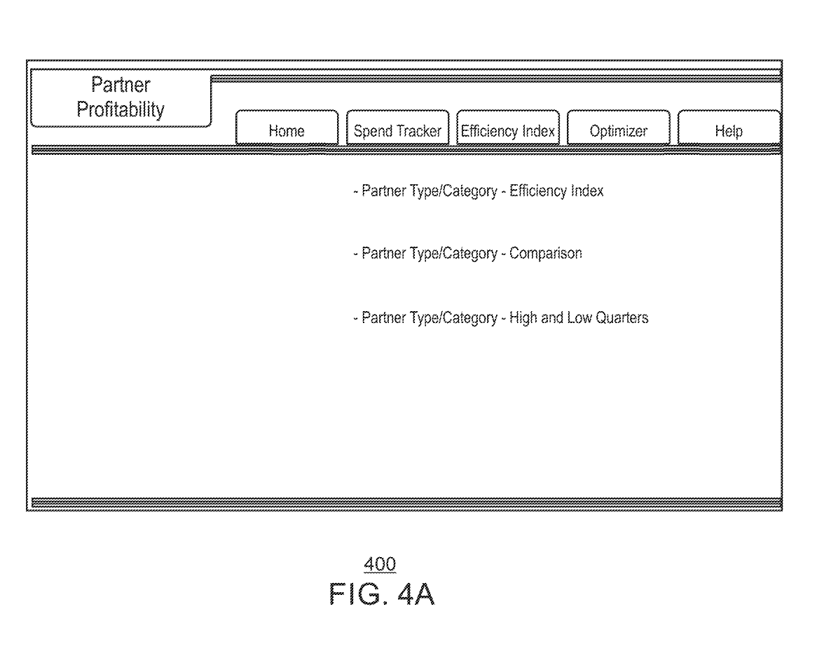

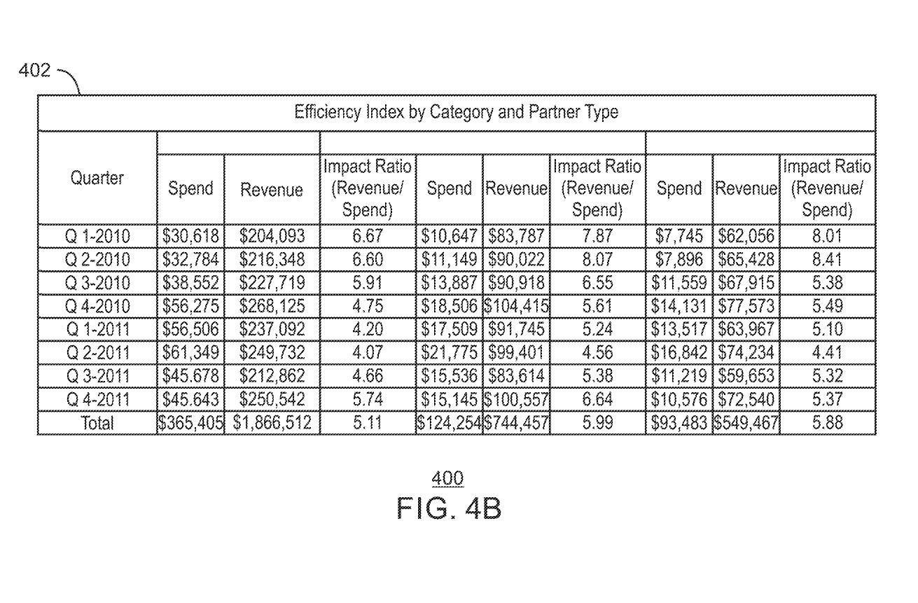

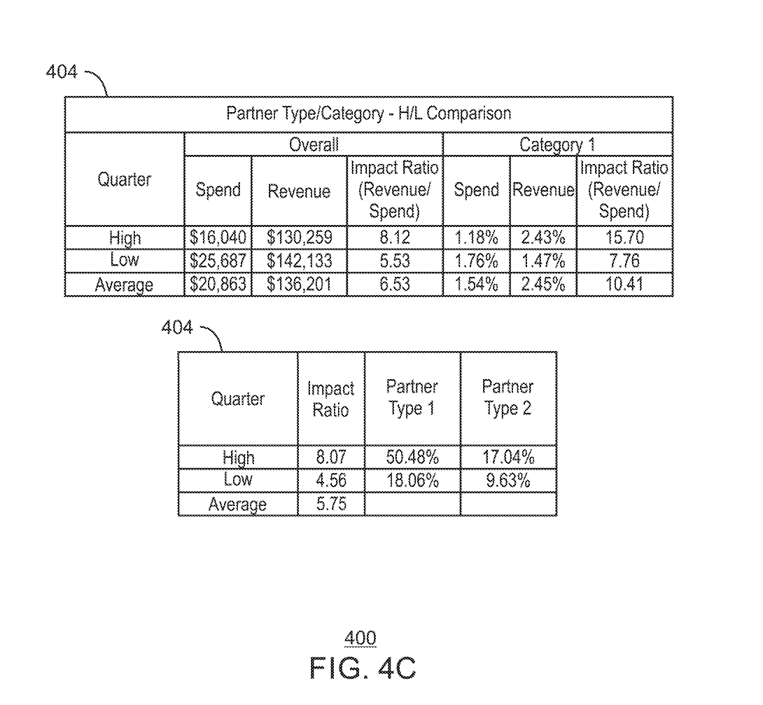

FIGS. 4A-4C are diagrams illustrating a graphical user interface associated with an efficiency tool. As illustrated in FIG. 4A, the graphical user interface of the efficiency tool 400 provides a portal to a visualization of an efficiency index, a partner type versus category comparison, and a partner type versus category visualization for high and low quarters. The efficiency tool 400 includes generating the efficiency index which is an impact ratio of contra value to the amount of revenue generated. As illustrated in table 402 of FIG. 4B, the impact ratio is a revenue amount divided by the contra value. The impact ratio may be a relatively quick way to view a contra value in terms of the revenue generated, and in some cases to understand the efficiency of resources being spent on any given partner type. As illustrated in FIG. 4C, the efficiency tool 400 may provide a visualization, as in table 404, of a quarter having a high impact ratio, a quarter having a low impact ratio, and an average impact ratio across multiple quarters. In one example, the impact ratio may be provided for various types of partnership categories as indicated in table 406. The visualization of impact ratios enable a user to quickly view contra values and their effecting revenue generation.

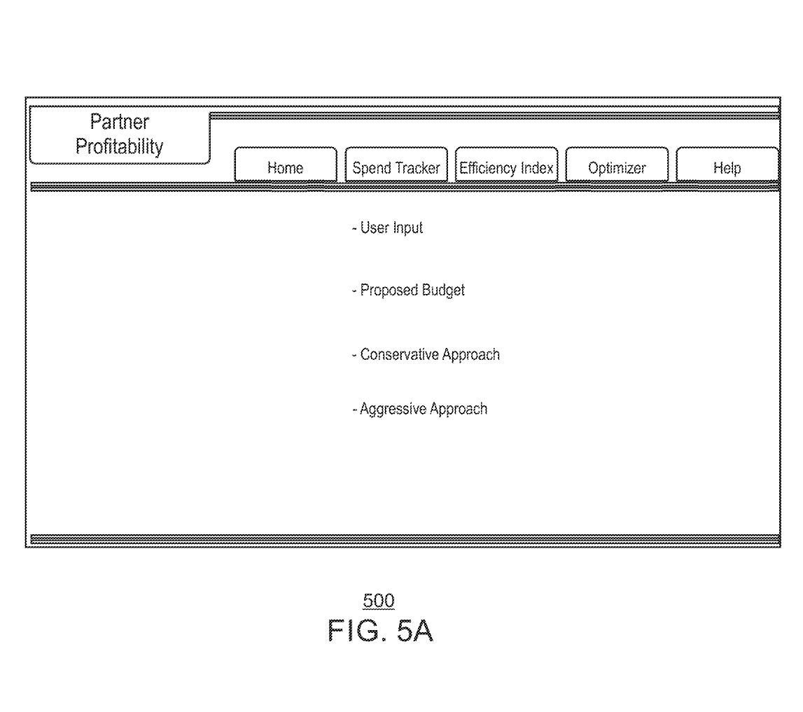

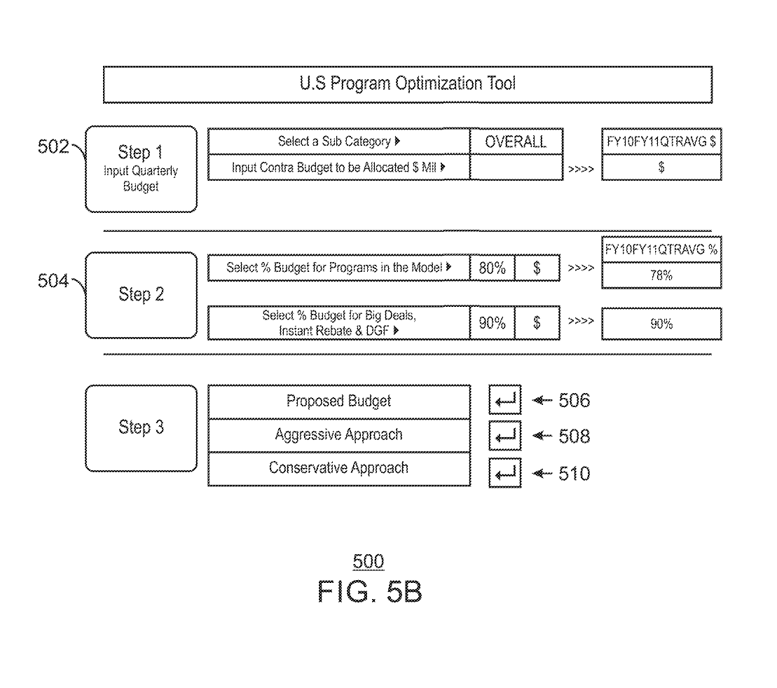

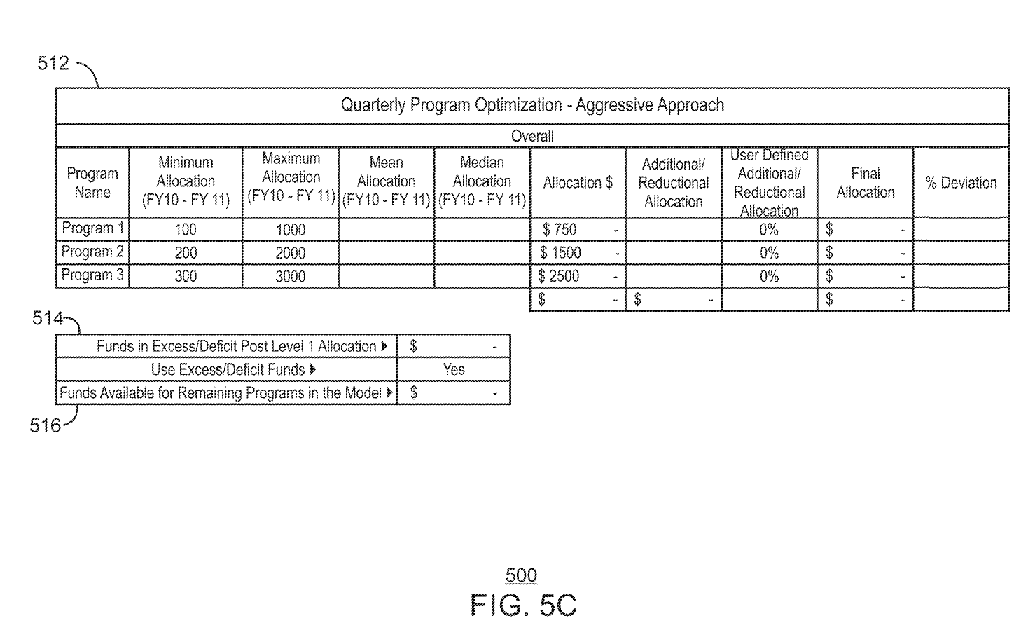

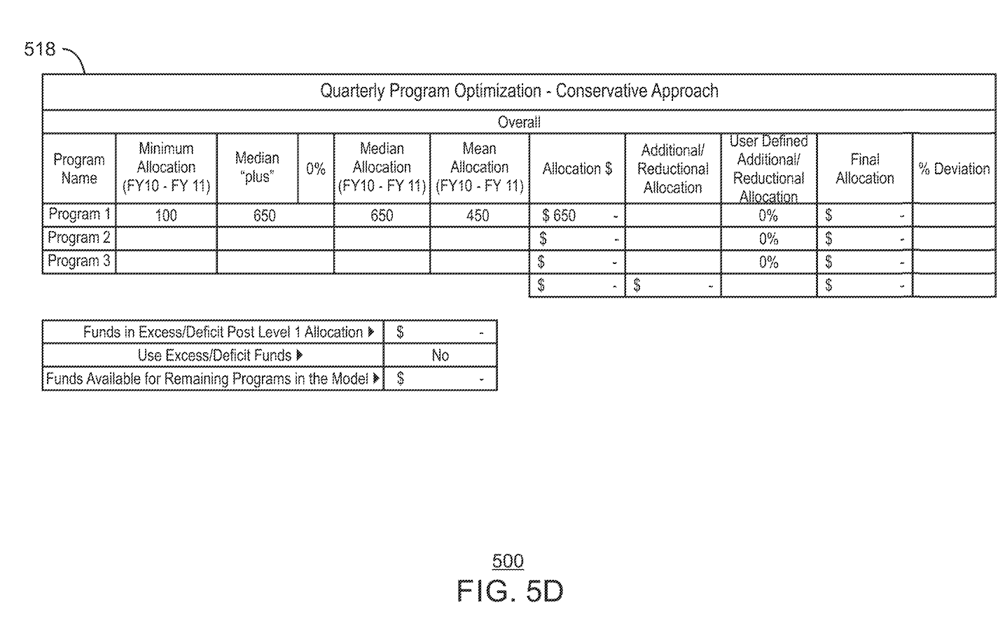

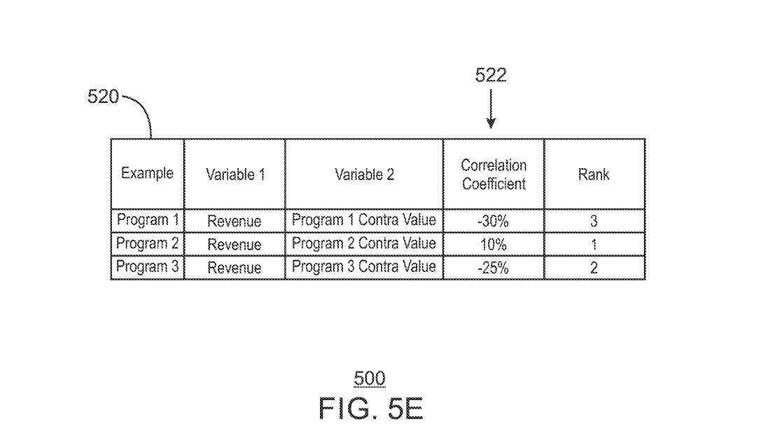

FIGS. 5A-5E are diagrams illustrating a graphical user interface associated with an optimization tool. The graphical user interface of the optimization tool 500 provides a portal to a visualization of proposed budgets based on an analysis of contra values, revenues generated, and the like. The proposed budgets may be conservative budgets or aggressive budgets. The proposed budgets may include an optimization value indicating a future amount to be allocated to a given partnership program based on factors based on a statistical model configured to predict allocations that will be effective in generating revenue. The statistical model may be generated by the optimization module 206 discussed above in reference to FIG. 2. To arrive at a statistical model, contra value data and revenue data may be mapped by quarter, partner and product line level. The final statistical model produces “coefficients” which represent the impact of each program on revenue at a partner and category level. Inputting these coefficients, the optimization value is calculated.

In one example, the statistical model may be a random effects model based on linear regression. A random effects model is a regression technique that may be useful in predicting outcomes for a given data set. The random effects model may be used to provide suggestions for allocating contra values in the future to various programs associated with a partnership between a first company and a second company. The optimization tool 500 may be used to determine coefficients indicating a rate of change of revenue based on historical contra values. The analytical capabilities of the optimization tool 500 identifies programs which have had a significant impact on maximizing the revenue, given fixed contra values.

As illustrated in FIG. 5B, the optimization tool 500 is configured to receive a value indicating an available budget for partnership programs, as indicated by the arrow 502. The optimization tool 500 is configured to receive percentage values, as indicated by the arrow 504. The percentage values may include the percentage of the available budget to be allocated for the programs in the statistical model. The percentage values may include the percentage of the available budget to be allocated for specific programs that may be of interest to a user of the optimization tool 500. For example, the user may want to focus on a select few programs which have historically been allocated a relatively large percentage relative to other programs.

The optimization tool 500 may receive an indication of a proposed budget based on the statistical model as indicated by the arrow 506. The proposed budget allocation 506 may allocate the available budget to be substantially similar to historical allocations. The optimization tool 500 may receive an indication of an aggressive budget as indicated by the arrow 508. The aggressive budget is an allocation having an upper limit equal to the historical contra value maximum, and a lower limit equal to the historical contra value minimum. The optimization tool 500 may receive an indication of a conservative budget as indicated by the arrow 510. The conservative budget is an allocation having an upper limit equal to the historical contra value maximum, and a lower limit equal to the historical contra value minimum.

As illustrated in FIG. 5B, the table 512 may indicate a proposed allocation using an aggressive approach. The table 512 indicates partnership programs having a historically significant impact on revenue and indicates a lower limit equal to the historical contra value minimum for each program, and an upper limit equal to the historical contra value maximum for each program. As an example, program 1 in table 512, indicates a historical contra value minimum of 100 and a historical contra value maximum of 1000, and an allocation of 750. The table 512 of FIG. 5B may also include a visualization of values associated with the proposed allocation based on the aggressive approach including the funds in excess or deficit after the allocation is determined 514, the funds available for remaining programs in the model 516, and the like.

As illustrated in FIG. 5C, the table 518 may indicate a proposed allocation using a conservative approach. The table 518 indicates partnership programs having a historically significant impact on revenue and indicates a lower limit equal to the historical contra value minimum for each program, and an upper limit equal to the historical contra value median. As an example, program 1 in table 518, indicates a historical contra value minimum of 100 and a historical contra value median of 650, and an allocation of 650. In contrast to the aggressive approach discussed above in reference to FIG. 5B, the conservative approach limits the upper limit of allocation to the historical contra value median.

FIG. 5E illustrates a ranking that may be provided by the optimization tool 500. The ranking may be provided to identify programs have had the most impact on revenue generation and the programs have had the least impact on revenue generation. The ranking may be based on a correlation between the contra values, or the amount spent on a particular partnership program, and the amount of revenue generated. The correlation may be associated with a correlation coefficient, indicated by the column 522 of the table 520. For example, FIG. 5E illustrates that program 2 is ranked number 1 out of the programs listed as it shows positive correlation between revenue compared to other two programs which have negative correlation. Among programs 1 and 3, program 3 is ranked higher because the degree of negativity is lower compared to program 1.

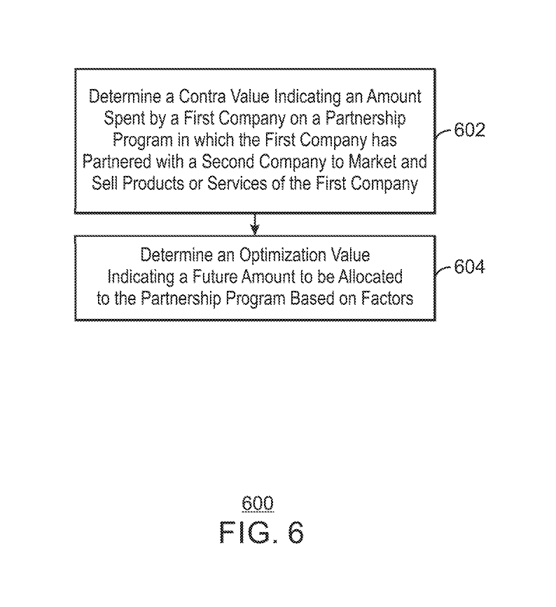

FIG. 6 is a block diagram illustrating a method for monitoring resources in a business partnership program. The method 600 may include determining, at block 602, a contra value indicating an amount spent by a first company on a partnership program in which the first company has partnered with a second company to market and sell products or services of the first company. The method 600 may include determining, at block 604, an optimization value indicating a future amount to be allocated to the partnership program based on factors.

In some examples, the contra value may be determined, at block 602, by a module, such as the tracking module 202, discussed above in reference to FIG. 2. The contra value may be a historical indication of the amount of money spent on a given partnership program. The determination, at block 602, may be carried out for a plurality of partnership programs, and may include presenting a plurality of visualizations of values associated with the contra value. For example, the method 600 may include determining values associated with the contra value including an aggregate contra value indicating an amount spent across a plurality of partnership programs. In some examples, a revenue amount generated based on a partnership type may be determined, wherein the partnership type indicates a type of partnership agreement between the first company and the second company. An aggregate contra value based on a product line and program type may be determined, wherein a product line is a category of products or services of the first company, and wherein a program type is a segmentation of a contra value allocated for specific objectives. An aggregate contra value based on a contra bucket may be determined, wherein a contra bucket includes a plurality of program types. An aggregate contra value and a revenue value generated based on a product category comprising product lines at a partner level may be determined, and a percentage value indicating the contra value as a percentage of revenue generated may be determined. In some examples, the values associated with the contra value may be determined by the tracking module 202, and the method 600 may include rendering, at a display of a computing system the values determined.

The optimization value may be a proposed budget for allocating resources to the partnership program. In some examples, the optimization value may be determined by a module, such as the optimization module 206 discussed above in reference to FIG. 2. The determination of the optimization value, at block 604, may be based on factors including coefficients indicating a rate of change of revenue based on historical contra values. The coefficients may be based on a linear regression analysis of the contra value and the values associated with the contra value. The factors also include a historical contra value minimum, a historical contra value maximum, and a historical contra value median.

In some examples, the optimization value may be determined by determining either a conservative allocation or an aggressive allocation. In the conservative allocation, an upper limit is equal to the historical contra value median, and a lower limit is equal to the historical contra value minimum. In the aggressive allocation, an upper limit is equal to the historical contra value maximum, and a lower limit is equal to the historical contra value minimum.

In some examples, an impact ratio may be determined. The impact ratio may be determined via a module, such as the efficiency module discussed above in reference to FIG. 2. The impact ratio is a proportion of the promotional allowance value to the revenue generated for the first company. The impact ratio may be a relatively quick way for a user to evaluate the effectiveness of the contra value has been in generating revenue.

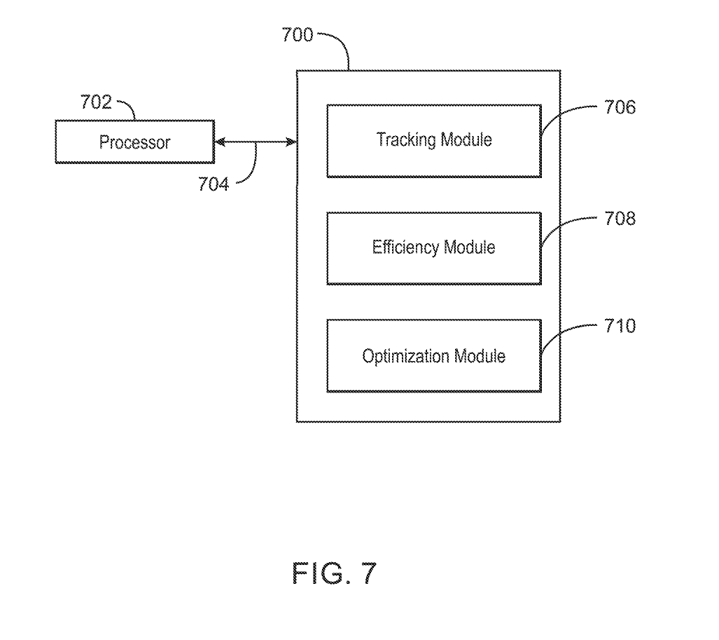

FIG. 7 is a block diagram showing a tangible machine-readable medium that stores code adapted to arrange video images associated with audiovisual streams in a multi-stream environment. The computer-readable medium is generally referred to by the reference number 700. The computer-readable medium 700 can comprise Random Access Memory (RAM), a hard disk drive, an array of hard disk drives, an optical drive, an array of optical drives, a non-volatile memory, a Universal Serial Bus (USB) flash drive, a DVD, a CD, and the like. In one embodiment of the present invention, the computer-readable medium 700 can be accessed by a processor 702 over a computer bus 704.

The various software components discussed herein can be stored on the tangible, non-transitory computer-readable medium 700 as indicated in FIG. 8. For example, a first block 706 can include a tracking module configured determine a contra value indicating an amount spent by a first company on a partnership program in which the first company has partnered with a second company to market and sell products or services of the first company. A second block 708 can include an efficiency module configured to determine an impact ratio associating the contra value to a revenue amount generated. A third block 710 can include an optimization module configured to determining, via an optimization module, an optimization value indicating a future amount to be allocated to the partnership program based on factors. The factors include coefficients indicating a rate of change of revenue based on historical contra values, a historical contra value minimum, a historical contra value maximum, and a historical contra value median.

Although shown as contiguous blocks, the software components can be stored in any order or configuration. For example, if the computer-readable medium 700 is a hard drive, the software components can be stored in non-contiguous, or even overlapping, sectors.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method of monitoring resources in a business partnership program, comprising:
determining, via a tracking module, a contra value indicating an amount spent by a first company on a partnership program in which the first company has partnered with a second company to market and sell products or services of the first company; and
determining, via an optimization module, an optimization value indicating a future amount to be allocated to the partnership program based on factors comprising:
coefficients indicating a rate of change of revenue based on historical contra values;
a historical contra value minimum;
a historical contra value maximum; and
a historical contra value median.

2. The method of claim 1, comprising determining, via the tracking module, values associated with the contra value, comprising:
an aggregate contra value indicating an amount spent across a plurality of partnership programs;
a revenue amount generated based on a partnership type, wherein the partnership type indicates a type of partnership agreement between the first company and the second company;
an aggregate contra value based on a product line and program type; wherein a product line is a category of products or services of the first company, and wherein a program type is a segmentation of a contra value allocated for specific objectives;
an aggregate contra value based on a contra bucket, wherein a contra bucket includes a plurality of program types;
an aggregate contra value and a revenue value generated based on a product category comprising product lines at a partner level; and
a percentage value indicating the contra value as a percentage of revenue generated.

3. The method of claim 2, comprising rendering, at a display of a computing system, the values determined by the tracking module.

4. The method of claim 1, determining, via an efficiency module, an impact ratio of the contra value to a generated revenue value, wherein the impact ratio is a proportion of the contra value to the revenue generated for the first company.

5. The method of claim 1, comprising determining the coefficients based on a linear regression analysis.

6. The method of claim 1, wherein determining the optimization value comprises:
determining a conservative allocation comprising an upper limit equal to the historical contra value median, and a lower limit equal to the historical contra value minimum; and
determining an aggressive allocation comprising an upper limit equal to the historical contra value maximum, and a lower limit equal to the historical contra value minimum.

7. A system for monitoring resources in a business partnership program, the system comprising:
a processing device; and
a system memory, wherein the system memory comprises code to direct the processing unit to:
determine a contra value indicating an amount spent by a first company on a partnership program in which the first company has partnered with a second company to market and sell products or services of the first company; and
determine an optimization value indicating a future amount to be allocated to the partnership program based on factors comprising:
coefficients indicating a rate of change of revenue based on historical contra values;
a historical contra value minimum;
a historical contra value maximum; and
a historical contra value median.

8. The system of claim 7, wherein the instructions direct the processor to determine values associated with the contra value, comprising:
an aggregate contra value indicating an amount spent across a plurality of partnership programs;
a revenue amount generated based on a partnership type, wherein the partnership type indicates a type of partnership agreement between the first company and the second company;
an aggregate contra value based on a product line and program type; wherein a product line is a category of products or services of the first company, and wherein a program type is a segmentation of a contra value allocated for specific objectives;
an aggregate contra value based on a contra bucket, wherein a contra bucket includes a plurality of program types;
an aggregate contra value and a revenue value generated based on a product category comprising product lines at a partner level; and
a percentage value indicating the contra value as a percentage of revenue generated.

9. The system of claim 8, wherein the instructions direct the processor to render, at a display of the computing system, the determine values associated with the contra value.

10. The system of claim 7, wherein the instructions direct the processor to determine an impact ratio of the contra value to a generated revenue value, wherein the impact ratio is a proportion of the contra value to the revenue generated for the first company.

11. The system of claim 7, wherein the instructions direct the processor to determine the coefficients based on a linear regression analysis.

12. The system of claim 7, wherein the instructions direct the processor to determine the optimization value include instructions to direct the processor to:
determine a conservative allocation comprising an upper limit equal to the historical contra value median, and a lower limit equal to the historical contra value minimum; and
determine an aggressive allocation comprising an upper limit equal to the historical contra value maximum, and a lower limit equal to the historical contra value minimum.

13. One or more non-transitory, tangible, computer-readable storage devices, comprising code configured to direct a processing unit to:
determining, via a tracking module, a contra value indicating an amount spent by a first company on a partnership program in which the first company has partnered with a second company to market and sell products or services of the first company; and
determining, via an optimization module, an optimization value indicating a future amount to be allocated to the partnership program based on factors comprising:
coefficients indicating a rate of change of revenue based on historical contra values;
a historical contra value minimum;
a historical contra value maximum; and
a historical contra value median.

14. The non-transitory, tangible, computer-readable storage devices of claim 13, comprising code configured to direct the processing unit to determine the coefficients based on a linear regression analysis.

15. The non-transitory, tangible, computer-readable storage devices of claim 13, wherein the code direct the processor to determine the optimization value include instructions to direct the processor to:
determine a conservative allocation comprising an upper limit equal to the historical contra value median, and a lower limit equal to the historical contra value minimum; and
determine an aggressive allocation comprising an upper limit equal to the historical contra value maximum, and a lower limit equal to the historical contra value minimum.
